(19) United States
(12) Patent Application Publication
(10) Pub. No.: US 2026/0267994 A1
(43) Pub. Date: Sep. 10, 2026

(54) VULNERABILITY CLASSIFICATION DETERMINATION SUPPORT SYSTEM AND VULNERABILITY CLASSIFICATION DETERMINATION SUPPORT METHOD

(71) Applicant: Hitachi, Ltd., Tokyo (JP)

(72) Inventors: Momoka KASUYA, Tokyo (JP); Nobuyoshi MORITA, Tokyo (JP)

(21) Appl. No.: 19/305,449

(22) Filed: Aug. 20, 2025

(30) Foreign Application Priority Data
Mar. 4, 2025 (JP) 2025-034050

(51) Int. Cl. G06F 21/57

(52) U.S. Cl. CPC G06F 21/577; G06F 2221/034

(57) ABSTRACT

A computer acquires vulnerability information from each of one or a plurality of information sources. The computer inputs the acquired vulnerability information or target vulnerability information, which is information after processing of the vulnerability information, to each of a plurality of kinds of extraction processing in which extraction conditions for extracting information for classification determination, which is information for classification determination of vulnerability, are different from one another, to acquire, for each of the plurality of kinds of extraction processing, information for classification determination output from the extraction processing based on an extraction condition corresponding to the extraction processing from the target vulnerability information. The computer outputs vulnerability classification determination support information, which is information based on information obtained by aggregating a plurality of pieces of information for classification determination output from the plurality of kinds of extraction processing.

### CROSS REFERENCE TO RELATED APPLICATION

This application relates to and claims the benefit of priority from Japanese Patent Application number 2025-034050, filed on Mar. 4, 2025 the entire disclosure of which is incorporated herein by reference.

### BACKGROUND

The present invention generally relates to a processing technique for vulnerability information representing vulnerability.

### Description of the Related Art

In products (for example, equipment and systems including the equipment), vulnerability of the products is often a starting point for a breach due to a cyberattack. Therefore, vulnerability measures are important in guaranteeing security of such products. In recent years, tightening of regulations concerning vulnerability has also occurred. Thus, vendor companies of the systems and the like described above are required to establish systems for quickly investigating causes of the vulnerability of their products, taking countermeasures, and disclosing information.

As a technique concerning vulnerability management, for example, a technique disclosed in Japanese Patent Laid-Open No. 2020-021309 is known.

Besides, a technique disclosed in Japanese Patent Laid-Open No. 2024-177129 is also known. According to the technique, information is extracted from a report such as a security report or a medical record using a machine learning-artificial intelligence (ML-AI) model.

### SUMMARY

Many pieces of vulnerability information disclosed include vulnerability information added or updated as appropriate. Even after shipment or release of a target product, vulnerability information is added and updated anew and disclosed. The burden of investigations for finding out vulnerability information relevant to the target product out of such many pieces of vulnerability information is large. It is difficult for a user to perform, for each of the pieces of vulnerability information, classification determination as to whether vulnerability represented by the vulnerability information is relevant to the target product.

A computer acquires vulnerability information from each of one or a plurality of information sources. The computer inputs the acquired vulnerability information or target vulnerability information, which is information after processing of the vulnerability information, to each of a plurality of kinds of extraction processing in which extraction conditions for extracting information for classification determination, which is information for classification determination of vulnerability, are different from one another, to acquire, for each of the plurality of kinds of extraction processing, information for classification determination output from the extraction processing based on an extraction condition corresponding to the extraction processing from the target vulnerability information. The computer outputs vulnerability classification determination support information, which is information based on information obtained by aggregating a plurality of pieces of information for classification determination output from the plurality of kinds of extraction processing.

According to the present invention, it is possible to make it easy for a user to perform classification determination as to whether vulnerability represented by vulnerability information is relevant to a target product.

### BRIEF DESCRIPTION OF THE DRAWINGS

FIG. 1 is a diagram illustrating a configuration example of a vulnerability classification determination support system in an embodiment;

FIG. 2 is a diagram illustrating a hardware configuration example of a server in the embodiment;

FIG. 3 is a diagram illustrating an example of vulnerability information in the embodiment;

FIG. 4 is a diagram illustrating an example of an information extraction target table in the embodiment;

FIG. 5 is a diagram illustrating an example of a viewpoint definition table in the embodiment;

FIG. 6 is a diagram illustrating a flow example of vulnerability classification determination support processing in the embodiment;

FIG. 7 is a diagram illustrating a prompt example in the embodiment;

FIG. 8 is a diagram illustrating a prompt example in the embodiment;

FIG. 9 is a diagram illustrating a flow example of details of S4 in FIG. 6;

FIG. 10 is a diagram illustrating a flow example of details of S7 in FIG. 6; and

FIG. 11 is a diagram illustrating an output example of check items in the embodiment.

### DETAILED DESCRIPTION

In the following explanation, a “processor” is an arithmetic operation device and may be one or more processor devices. At least one processor device may be typically a microprocessor device such as a CPU (Central Processing Unit) but may be a processor device of another type such as a GPU (Graphics Processing Unit). The at least one processor device may be a single core or may be a multi-core. The at least one processor device may be a processor core. The at least one processor device may be a processor device in a broad sense such as a hardware circuit that performs a part or entire processing (for example, an FPGA (Field-Programmable Gate Array), a CPLD (Complex Programmable Logic Device), or an ASIC (Application Specific Integrated Circuit)).

In the following explanation, a “storage device” may be one or more permanent storage devices, which is an example of one or more storage devices. The permanent storage device may be typically a nonvolatile storage device and may be specifically, for example, a HDD (Hard Disk Drive), an SSD (Solid State Drive), or an NVMe (Non-Volatile Memory Express) drive.

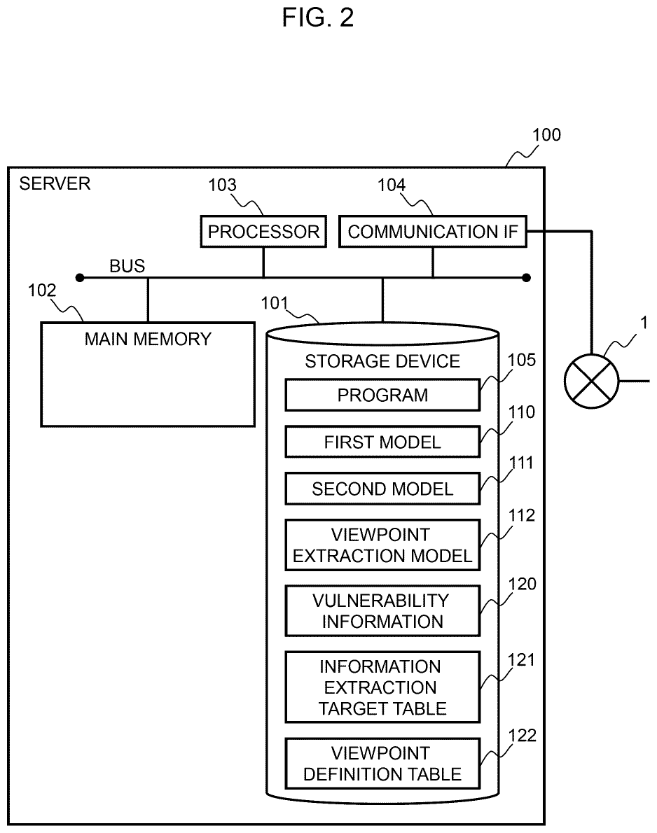

In the following explanation, a “main memory” is an example of a memory and is one or more memory devices, which are an example of one or more storage devices. At least one or more memory devices in the main memory may be a volatile memory device or may be a nonvolatile memory device. Note that a main memory explained in the present embodiment (corresponding to a main memory 102 illustrated in FIG. 2) is a main storage device and, as an example, indicates the volatile memory device described above.

In the following explanation, a “communication IF” may be one or more communication interface devices (corresponding to a communication IF 104 illustrated in FIG. 2). The one or more communication interface devices may be one or more communication interface devices (for example, one or more NICs (Network Interface Cards) of the same type or may be two or more communication interface devices (for example, an NIC and an HBA (Host Bus Adapter)) of different types.

In the following explanation, information output in response to input is sometimes explained with expressions such as an “AAA table” and an “AAA database”. However, the information may be data having any structure (for example, the information may be structured data or may be unstructured data) or may be a model represented by a neural network, a genetic algorithm, or a random forest that generates output responding to input. Therefore, the “AAA table” and the “AAA database” can be referred to as “AAA information”. In the following explanation, configurations of databases and tables are examples. One database or table may be divided into two or more databases or tables or all or some of two or more databases or tables may be one database or table.

In the following explanation, processing is sometimes explained with the term “program” as a subject. However, the program is executed by a processor such as a CPU to perform decided processing while using, for example, a storage device and/or interface device as appropriate. Therefore, the subject of the processing may be the CPU (or a device such as a controller including the processor). The program may be installed in a device such as a computer from a program source. The program source may be, for example, a (for example, non-transitory) recording medium readable by a program distribution server or a computer. In the following explanation, two or more programs may be implemented as one program or one program may be implemented as two or more programs.

In the following explanation, when elements of the same type are explained without being distinguished, a common portion in reference signs is sometimes used and, when the elements of the same type are distinguished and explained, the reference signs or identifiers of the elements are sometimes used.

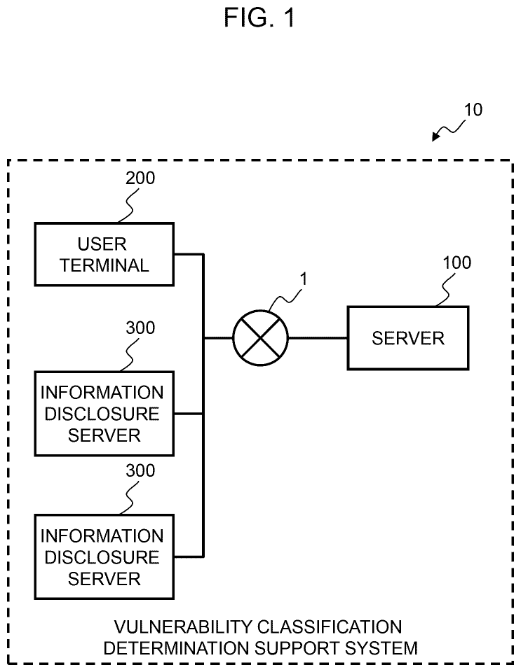

FIG. 1 is a diagram illustrating a configuration example of a vulnerability classification determination support system 10 in an embodiment.

The vulnerability classification determination support system 10 is an information processing system capable of efficiently and accurately generating and presenting clear check items concerning a target product from enormous vulnerability information. The vulnerability classification determination support system 10 is mainly configured by a server 100. Naturally, at least one of a user terminal 200 and an information disclosure server 300 connected to a network 1 may be included in the vulnerability classification determination support system 10.

The vulnerability classification determination support system 10 may be a computer system configured on one physical computer or on a plurality of logically or physically configured computers. The system 10 may operate on a virtual computer constructed on a plurality of physical computer resources. The vulnerability classification determination support system 10 may be configured on the cloud or may be on-premises configured on a specific computer (hardware).

The network 1 may be, for example, a wired LAN (Local Area Network), a wireless LAN, a WAN (Wide Area Network), the Internet, or a mobile phone network but is not limited thereto in any case. Here, as an example of the mobile phone network or the like, a general public line network, which is either wired or wireless, for example, a fifth generation mobile communication system, a so-called 5G (5 th Generation), that has enabled “multiple simultaneous connections” and “ultralow latency” may be used.

The server 100 can access, via the network 1, the information disclosure server 300, which is an example of an information source of vulnerability information 120, and collect the vulnerability information 120 from the information disclosure server 300. The information disclosure server 300 may be typically a vulnerability information database. A plurality of information disclosure servers 300 may be present.

FIG. 2 is a diagram illustrating a hardware configuration example of the server 100

The server 100 may be implemented by one or more physical computers. The server 100 includes a storage device 101, a main memory 102, a processor 103 (example: a CPU: Central Processing Unit), a communication interface (communication IF) 104, and a bus that connects these units. The bus is an information transmission medium such as a cable.

The storage device 101 is, for example, a large capacity magnetic storage device or a semiconductor storage device such as a HDD (Hard Disk Drive) or an SSD (Solid State Drive) and stores a program 105 to be executed by the processor 103 and a first model 110, a second model 111, and a viewpoint extraction model 112, vulnerability information 120, an information extraction target table 121, and a viewpoint definition table 122 explained in detail below. Each of the models 110, 111, and 112 may be a machine learning model or may be a large-scale language model (LLM). The first model 110 and the second model 111 may be, for example, a first generative AI (Artificial Intelligence) or a second generative AI. One of the first model 110 and the second model 111 may be absent.

The main memory 102 is a semiconductor storage device such as a RAM (Random Access Memory) and temporarily stores the program 105 to be loaded from the storage device 101 and executed by the processor 103 and necessary work data.

The processor 103 reads out the program 105 stored in the storage device 101 to the main memory 102 and executes the program 105 to implement functions of the server 100. The processor 103 executes vulnerability classification determination support processing in the present embodiment using the first model 110, the second model 111, and the viewpoint extraction model 112. Note that a part of processing performed by the processor 103 executing the program 105 may be executed by another arithmetic operation device (hardware such as an ASIC or an FPGA). The program 105 to be executed by the processor 103 may be provided to the server 100 of the vulnerability classification determination support system 10 via a removable medium (a CD-ROM, a flash memory, or the like) or the network 1 and stored in the storage device 101. The communication IF 104 is connected to the network 1.

Next, specific configuration examples of various data used by the vulnerability classification determination support system 10 will be explained.

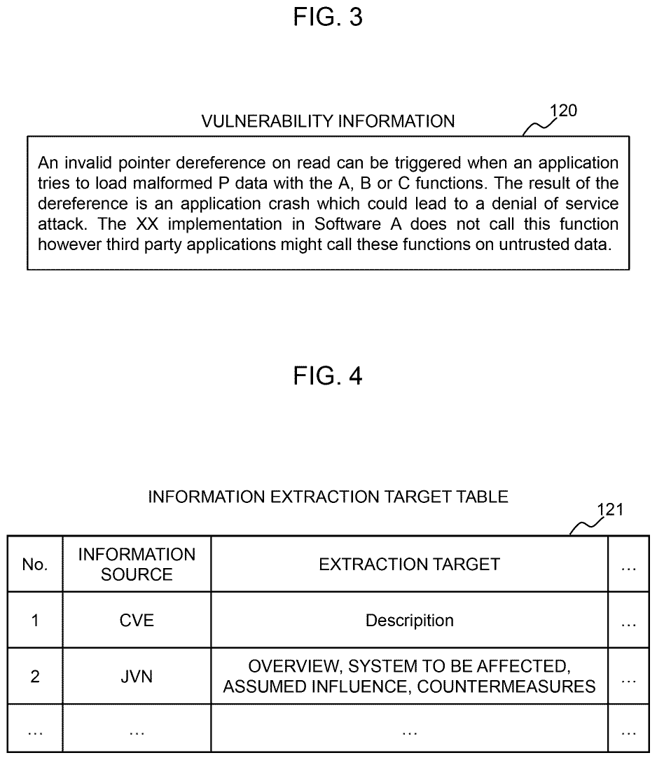

FIG. 3 illustrates an example of the vulnerability information 120.

The vulnerability information 120 is information that the server 100 acquires from the information disclosure server 300 periodically or at any time immediately every time the information is disclosed. The vulnerability information 120 to be disclosed is different depending on the information disclosure server 300 (the vulnerability information database), which is the information source of the vulnerability information 120. Specifically, CVE (Vulnerabilities and Exposures) and JVN (Japan Vulnerability Notes) are targets of the vulnerability information 120. Note that the CVE is an identifier targeting vulnerability in an individual product and numbered by a nonprofit company supported by the US government. The JVN is a vulnerability countermeasure information portal site with the purpose of providing vulnerability related information and countermeasure information therefor such as software used in Japan and contributing to information security countermeasures.

FIG. 4 is a diagram illustrating a configuration example of the information extraction target table 121.

The information extraction target table 121 is a table defining information that should be extracted from the vulnerability information 120. Entries of the information extraction target table 121 include fields of No., an information source, and an extraction target 3 in the vulnerability information 120 from the information source.

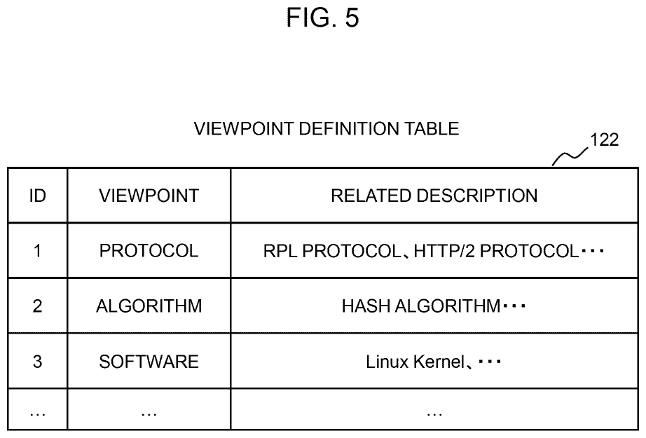

FIG. 5 is a diagram illustrating a configuration example of the viewpoint definition table 122.

The viewpoint definition table 122 is a table associating and defining, for each of viewpoints concerning product element types relating to vulnerability, descriptions and keywords that can be included in the vulnerability information 120. Entries of the viewpoint definition table 122 include fields of an ID, a viewpoint, and a related description. Note that the “product element types” are types of elements that can be elements of a product. There are, for example, a protocol, an algorithm, and software as the product element types. The “product” may be either a hardware product or a software product.

Next, the vulnerability classification determination support processing in the present embodiment will be explained.

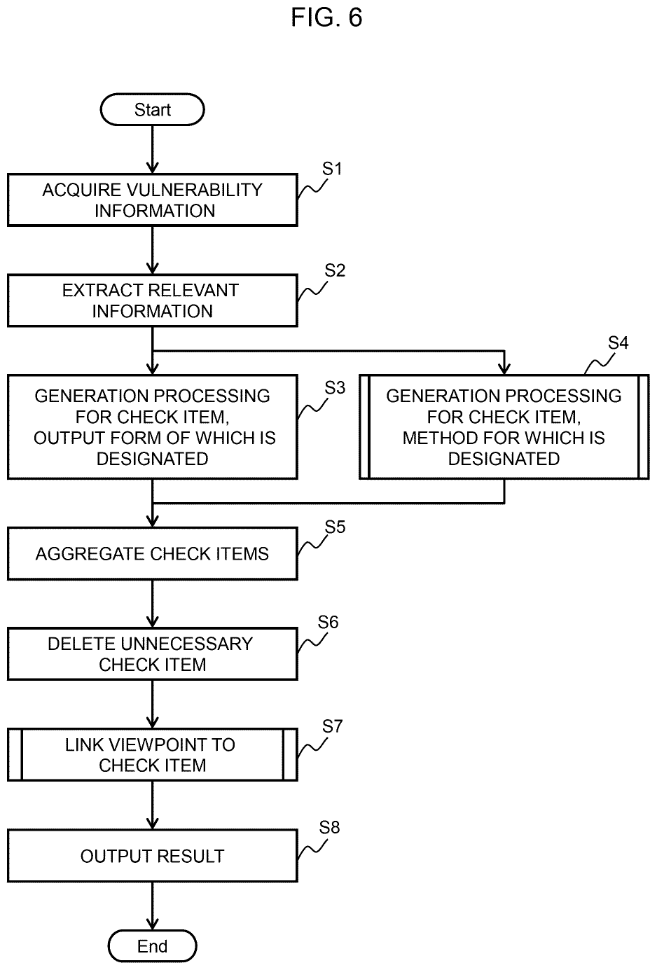

FIG. 6 is a flow example of the vulnerability classification determination support processing. This processing is performed by the processor 103 of the server 100 executing the program 105. However, for simplification of explanation, an entity of the processing is assumed to be the “processor 103”.

The processor 103 acquires the vulnerability information 120 from the information disclosure server 300 via the communication IF 104, for example, every fixed period (S1). Accordingly, the vulnerability information 120 is input via the communication IF 104. The vulnerability information 120 (see FIG. 3) acquired (input) here is stored in the storage device 101 by the processor 103.

Subsequently, the processor 103 collates the vulnerability information 120 acquired in S1 and information concerning an information source thereof (for example, information acquired from the information disclosure server 300) with the information extraction target table 121 to specify information that should be extracted from the vulnerability information 120 obtained from the target information source and extracts the information from the vulnerability information 120 (S2). For example, when the information source is “CVE”, “Description” is an extraction target (see FIG. 4). When the information source is “JVN”, “an overview, a system to be affected, an assumed influence, and countermeasures” is an extraction target (see FIG. 4). This processing may be an example of processing of the input vulnerability information 120. The input vulnerability information 120 may be processed by another method instead of or in addition to the information extraction from the vulnerability information 120. For example, besides the information corresponding to the information source of the vulnerability information 120, information relevant to a predetermined condition may be extracted from the vulnerability information 120 or may be subjected to predetermined arithmetic processing. The processing, an example of which is S2, may not be always present.

A plurality of kinds of extraction processing in which extraction conditions for extracting vulnerability check items (an example of information for classification determination) are different from one another are prepared. The plurality of kinds of extraction processing may include first extraction processing in which the first model 110 is used and second extraction processing in which the second model 111 (or the first model 110) is used. Each of the models 110 and 111 may be a generative AI. Each of the models 110 and 111 may be present in an external site of the server 100. In this case, information (for example, a prompt) may be input to the external site via the network 1 for input to the models 110 and 111. Output information of the models 110 and 111 may be acquired from the external site via the network 1. At least one of the models 110 and 111 may be a learned model that has finished learning concerning extracting information for classification determination according to an extraction condition corresponding to extraction processing. An example of the first extraction processing is S3 and an example of the second extraction processing is S4.

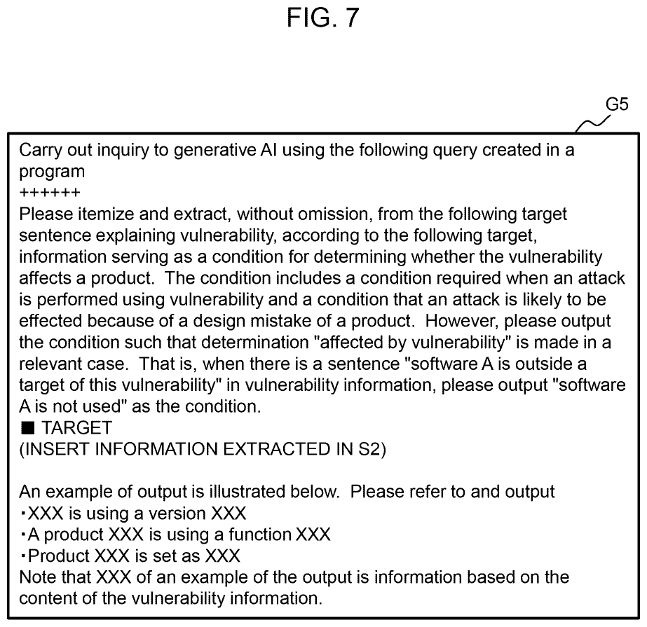

The processor 103 inputs a prompt G5, which is a prompt designating an output form and is a prompt concerning generation of a check item (an example of information for classification determination), to the first model 110 and generates information concerning the check item (S3). The prompt G5 describes, as exemplified in FIG. 7, premised on designation about an output form, extracting, by itemization, without omission, information serving as conditions for determining whether vulnerability affects a product among pieces of information indicated by the vulnerability information 120. The generated check item may be an item serving as information extracted from information that is a part of the prompt (information including the information extracted in S2).

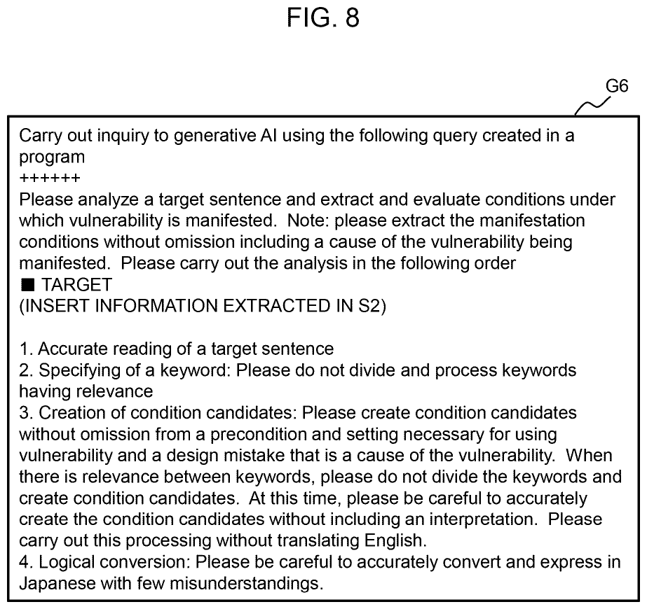

The processor 103 inputs a prompt G6, which is designated about a generation method for the check item, concerning generation of the check item to the second model 111 and generates information concerning the check item (S4). As exemplified in FIG. 8, the prompt G6 describes, premised on designation about an extraction method such as a sentence analysis, extracting and evaluating conditions and causes of manifestation of vulnerability among the pieces of information indicated by the vulnerability information 120. The generated check item may be an item serving as information extracted from information that is a part of the prompt (information including the information extracted in S2).

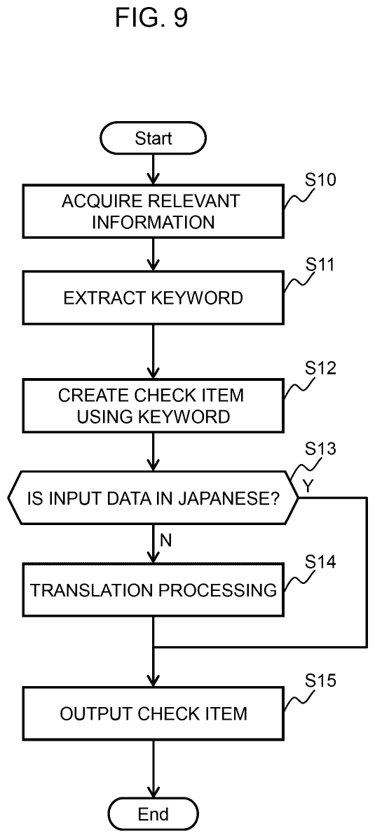

Note that the processing in S4 explained above may include, as indicated by a detailed flow illustrated in FIG. 9, various kinds of processing such as keyword extraction from the information obtained in S2 (S10 and S11), check item generation using the keyword (S12), translation processing (S13 and S14) in the case in which input data (information obtained in S10 from the vulnerability information 120) is written in other than Japanese, and output of the check item (S15).

Among these kinds of processing, the keyword extraction (S11) may include, for example, extracting, with the second model 111 or with a known keyword matching tool, from the information obtained in S2 explained above, a specific keyword (a table defining the keyword or learned content in the second model) assumed to be highly likely to be included as a check item.

The check item generation using the keyword (S12) is, for example, processing of document creation of a check item by the second model 111. In this case, it is assumed that the second model 111 has learned about at least a correspondence relation between the specific keyword and a sentence considered suitable as a check item for classification determination and is capable of receiving input of a prompt including the keyword obtained in S11 and generating a check item.

The translation processing (S14) is processing for inputting the sentence of the check item obtained in S12 to a translation function included in advance in the second model 111 or a translation function of calling and using an external service of a large-scale language model or the like and translating the sentence into Japanese. That is, in the respective kinds of processing in S10 to S12 before S13, information deriving from the vulnerability information 120 of an English sentence is directly processed.

Here, the flow illustrated in FIG. 6 is explained again. Subsequently, the processor 103 collates the check items respectively acquired in S3 and S4 explained above (at least check items of two patterns including the check pattern obtained by designating the output form and the check item obtained by designating an extraction method) and, if there is an overlapping part between both the check items, aggregates the check items into, of the check items including the content, the check item having the larger information amount (S5). In other words, for example, of the overlapping check items, the check item having a smaller information amount is not selected and the check item having a larger information amount is selected.

Specifically, for example, when pieces of information of two patterns including “a function A is used” and “a function A, a function B, or a function C is used” are collated as check items, although both the check items are check items having information that can overlap, the processor 103 selects “a function A, a function B, or a function C is used” having a larger information amount.

The processor 103 deletes, among the plurality of check items, for example, information concerning an attack method to vulnerability (example, refer to information for a server of AA in a period of **) and an event that a human cannot sense (example: processing concerning internal processing of a server) (S6). By performing such processing, it is easy to avoid a useless check item (that a person in charge cannot determine) mixing in a final result. Note that the information concerning an attack method to vulnerability and the information concerning an event that a human cannot sense are examples of information relevant to a deletion condition that is a condition defined as unrelating to support of classification determination as to whether vulnerability is relevant to a target product.

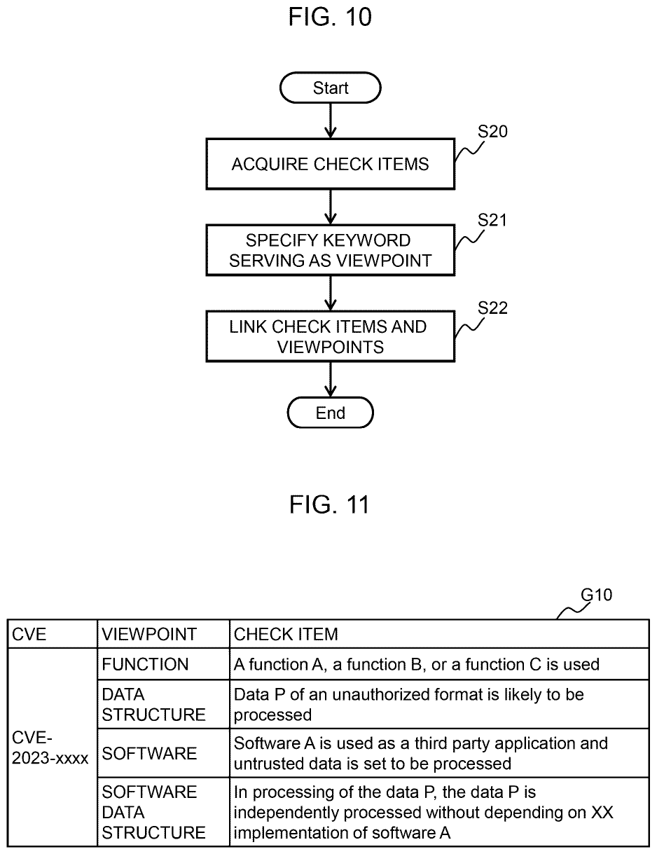

Subsequently, the processor 103 specifies and links a viewpoint concerning the check items obtained by the processing up to this point (S7). Details of this processing are illustrated in the flow illustrated in FIG. 10. In this case, the processor 103 acquires the check items obtained up to S6 (S20) and collates the check items with the viewpoint definition table 122 (see FIG. 5) to specify a viewpoint (S21). In the example of the viewpoint definition table 122 illustrated in FIG. 5, when the check item includes a keyword “RPL protocol”, “protocol” is specified as the viewpoint. The processor 103 carries out such viewpoint specifying processing respectively for the check items. The processor 103 links the viewpoint specified in S21 explained above with the check item (S22). As another method of (S21), a method of extracting, using a generative AI, from the check item, words relating to the viewpoint defined beforehand illustrated in FIG. 5 may be adopted instead of or in addition to the method of using a keyword or another method may be adopted.

Here, the flow illustrated in FIG. 6 is explained again. The processor 103 outputs the information obtained in S22, that is, the information in which the check item and the viewpoint are linked, to the user terminal 200 as output information G10 (S8) and ends this flow. A specific example of the output information G10 is illustrated in FIG. 11. In the example illustrated in FIG. 11, in the output information G10, for CVE “CVE-2023-xxxx”, a viewpoint “function” and a check item “a function A, a function B, or a function C is used”, a viewpoint “data structure” and a check item “data P of an unauthorized format is likely to be processed”, a view point “software” and a check item “software A is used as a third party application and untrusted data is set to be processed”, and a viewpoint “software, data structure” and a check item “In processing of data P, the data P is independently processed without depending on XX implementation of the software A” are respectively described.

A person in charge who performs classification determination of vulnerability information is capable of, while viewing the output information G10 with the user terminal 200 and understanding a simple viewpoint, imaging, concerning a determination target product or the like, content of a check item that is specific content of the viewpoint and efficiently performing the classification determination.

As explained above, with the vulnerability classification determination support system in the present embodiment, it is possible to efficiently and accurately generate a clear check item concerning a target product from enormous vulnerability information and present the check item.

Note that the present invention is not limited to the embodiment explained above and includes various modifications and equivalent configurations within the gist of the appended claims. For example, the embodiment explained above is explained in detail in order to clearly explained the present invention. The present invention is not always limited to an embodiment including all the configurations explained above. Some of configurations of a certain embodiment may be replaced with configurations of another embodiment. Configurations of another embodiment may be added to configurations of a certain embodiment. Other configurations may be added to, deleted from, and replaced with some of configurations of embodiments.

The above various explanations can be summarized, for example, as follows. The following summary may include supplementary explanation of the above explanation and explanation of modifications.

A vulnerability classification determination support system (for example, the vulnerability classification determination support system 10) includes an interface device (for example, the communication IF 104), a storage device (for example, the storage device 101 and the main memory 102), and a processor (for example, the processor 103). The processor acquires vulnerability information (for example, the vulnerability information 120) from each of one or a plurality of information sources (for example, one or a plurality of vulnerability information databases such as one or a plurality of information disclosure servers 300) through the interface device. The processor stores the acquired vulnerability information in the storage device. The processor inputs input (stored) vulnerability information or target vulnerability information, which is information after processing of the vulnerability information (for example, the information after S2) to each of a plurality of kinds of extraction processing (for example, the processing of performing the processing in S3 and using a model such as a machine learning model or a language model and, for example, the processing of performing the processing in S4 and using a model such as a machine learning model or a language model) in which extraction conditions for extracting information for classification determination (for example, a check item), which is information for classification determination of vulnerability, are different from one another, to acquire, for each of the plurality of kinds of extraction processing, from the target vulnerability information, information for classification determination output from the extraction processing based on an extraction condition corresponding to the extraction processing. The processor aggregates a plurality of pieces of information for classification determination output from the plurality of kinds of extraction processing (for example, S5, S6, and S7). The processor outputs vulnerability classification determination support information, which is information based on information obtained by aggregating the plurality of pieces of information for classification determination (for example, S8). One or more pieces of information for classification determination represented by the output vulnerability classification determination support information, for example, one or more check items may be displayed on an input and output device (for example, the user terminal 200) at an output destination.

Accordingly, it is possible to make it easy for a user to perform classification determination as to whether vulnerability represented by vulnerability information is relevant to a target product. Specifically, for example, it is possible to efficiently and accurately generate a clear check item concerning a target product from enormous vulnerability information and present the check item to the user. That is, the vulnerability classification determination support information supports classification determination as to whether the vulnerability represented by the target vulnerability information is relevant to a target product. Note that at least one of the plurality of kinds of extraction processing may be processing of using a learned model (for example, a machine learning model or a generative AI) that has finished learning concerning extracting the information for classification determination according to an extraction condition corresponding to the extraction processing.

The aggregation of the plurality of pieces of information for classification determination (for example, S5, S6, and S7) may include selecting information for classification determination having a large information amount among overlapping pieces of information for classification determination among the plurality of pieces of information for classification determination (for example, S5). Accordingly, it is possible to eliminate useless overlapping of information and extract and present necessary information without omission.

The aggregation of the plurality of pieces of information for classification determination (for example, S5, S6, and S7) may include deleting, from the plurality of pieces of information for classification determination, information relevant to a deletion condition, which is a condition defined as being unrelated to support of classification determination as to whether vulnerability is relevant to a target product. Accordingly, it is possible to avoid extracting and presenting a useless check item (for example, a check item that cannot be checked at the time of classification determination by a human).

Each of the one or the plurality of information sources may be a vulnerability information database on a network. The processor may perform, as processing of vulnerability information, extracting, from the vulnerability information, information corresponding to a vulnerability information database serving as an information source of the vulnerability information (for example, S2). Target vulnerability information serving as information after the processing may be configured by information extracted according to a vulnerability information database serving as an information source of input vulnerability information. Accordingly, it is possible to carry out, as pre-processing, efficient information extraction based on characteristics of each of the pieces of vulnerability information.

The processor may correlate viewpoint information, which is information representing a viewpoint of classification determination, with each of one or more pieces of information for classification determination in information serving as an aggregation result. The vulnerability classification determination support information may include, for each of the one or more pieces of information for classification determination, the information for classification determination and viewpoint information correlated with the information for determination information. Therefore, for example, in addition to one or more check items, for each of the one or more check items, a viewpoint correlated with the check item may be displayed. Accordingly, it is possible to present a value of the viewpoint as information with which, for example, a person in charge of classification determination can simply understand the check item.

The plurality of pieces of extraction processing may include first extraction processing and second extraction processing. The first extraction processing may be processing of inputting, to a first generative AI (for example, the first model 110), a prompt (for example, the prompt 5G), which designates, as a first extraction condition corresponding to the first extraction processing, an output form for extracting information for classification determination from target vulnerability information, to acquire information for classification determination including information extracted from target vulnerability information in response to the input of the prompt. The second extraction processing may be processing of inputting, to the first generative AI or a second generative AI (for example, the second model 111), a prompt (for example, the prompt 6G), which designates, as a second extraction condition corresponding to the second extraction processing, a method for extracting information for classification determination from target vulnerability information, to acquire information for classification determination including information extracted from the target vulnerability information in response to the input of the prompt. As explained above, information for classification determination for supporting (facilitating) classification determination by the user is obtained using, besides information for classification determination acquired by designation in a viewpoint that is output form designation, information for classification determination acquired by designation in a viewpoint of method designation. The method designation may be designation of one or more keywords.

1. A vulnerability classification determination support system comprising:
an interface device;
a storage device; and
a processor,
the processor:
acquiring vulnerability information from each of one or a plurality of information sources through the interface device;
storing the acquired vulnerability information in the storage device;
inputting the stored vulnerability information or target vulnerability information, which is information after processing of the vulnerability information, to each of a plurality of kinds of extraction processing in which extraction conditions for extracting information for classification determination, which is information for classification determination of vulnerability, are different from one another, to acquire, for each of the plurality of kinds of extraction processing, information for classification determination output from the extraction processing based on an extraction condition corresponding to the extraction processing from the target vulnerability information; and
outputting vulnerability classification determination support information, which is information based on information obtained by aggregating a plurality of pieces of information for classification determination output from the plurality of kinds of extraction processing.

2. The vulnerability classification determination support system according to claim 1, wherein at least one of the plurality of kinds of extraction processing is processing of using a learned model that has finished learning concerning extracting information for classification determination according to an extraction condition corresponding to the extraction processing.

3. The vulnerability classification determination support system according to claim 1, wherein the aggregating the plurality of pieces of information for classification determination includes selecting information for classification determination having a large information amount among overlapping pieces of information for classification determination among the plurality of pieces of information for classification determination.

4. The vulnerability classification determination support system according to claim 1, wherein the aggregating the plurality of pieces of information for classification determination includes deleting, from the plurality of pieces of information for classification determination, information relevant to a deletion condition, which is a condition defined as being unrelated to support of classification determination as to whether vulnerability is relevant to a target product.

5. The vulnerability classification determination support system according to claim 1, wherein
each of the one or the plurality of information sources is a vulnerability information database on a network,
the processor performs, as processing of the vulnerability information, extracting, from the vulnerability information, information corresponding to a vulnerability information database serving as an information source of the vulnerability information, and
the target vulnerability information serving as information after the processing is configured by information extracted according to a vulnerability information database serving as an information source of the input vulnerability information.

6. The vulnerability classification determination support system according to claim 1, wherein
the processor correlates viewpoint information, which is information representing a viewpoint of classification determination, with each of one or more pieces of information for classification determination in information serving as a result of the aggregation, and
the vulnerability classification determination support information includes the information for classification determination and viewpoint information correlated with the information for classification determination for each of the one or more pieces of information for classification determination.

7. The vulnerability classification determination support system according to claim 1, wherein
the plurality of kinds of extraction processing include first extraction processing and second extraction processing,
the first extraction processing is processing of inputting, to a first generative AI (Artificial Intelligence), a prompt, which designates, as a first extraction condition corresponding to the first extraction processing, an output form for extracting information for classification determination from the target vulnerability information, to acquire information for classification determination including information extracted from the target vulnerability information in response to the input of the prompt, and
the second extraction processing is processing of inputting, to the first generative AI or a second generative AI, a prompt, which designates, as a second extraction condition corresponding to the second extraction processing, a method for extracting information for classification determination from the target vulnerability information, to acquire information for classification determination including information extracted from the target vulnerability information in response to the input of the prompt.

8. The vulnerability classification determination support system according to claim 7, wherein the designation of the method is designation of one or more keywords.

9. A vulnerability classification determination support method for performing with a computer:
acquiring vulnerability information from each of one or a plurality of information sources;
inputting the acquired vulnerability information or target vulnerability information, which is information after processing of the vulnerability information, to each of a plurality of kinds of extraction processing in which extraction conditions for extracting information for classification determination, which is information for classification determination of vulnerability, are different from one another, to acquire, for each of the plurality of kinds of extraction processing, information for classification determination output from the extraction processing based on an extraction condition corresponding to the extraction processing from the target vulnerability information; and
outputting vulnerability classification determination support information, which is information based on information obtained by aggregating a plurality of pieces of information for classification determination output from the plurality of kinds of extraction processing.
